(19) United States
(12) Patent Application Publication
(10) Pub. No.: US 2023/0142148 A1
(43) Pub. Date: May 11, 2023

(54) Automated Deployment of Enterprise Archive with Dependency on Application Server Via Script

(71) Applicant: International Business Machines Corporation, Armonk, NY (US)

(72) Inventor: Abhayananda Ghosh, Santa Rosa Beach, FL (US)

(21) Appl. No.: 17/454,142

(22) Filed: Nov. 9, 2021

(51) Int. Cl. G06F 9/48; G06F 8/65; G06F 8/61; G06F 8/71; H04L 29/08

(52) U.S. Cl. CPC G06F 9/4881; G06F 8/65; G06F 8/62; G06F 8/71; H04L 67/10

(57) ABSTRACT

A computer implemented method, computer system, and computer program product for automated deployment of an updated configuration to a computer system. A set of management objects are provided that enable commands and command parameters to configure an environment. Using the set of management objects, a set of applications re that are installed in a current configuration. A deployment script to automatically deploy an updated configuration. In executing the deployment script, for each application to be installed, if a version of the application is running, the application is stopped. For each application to be installed, if a version of the application is installed in the current configuration, the application is uninstalled. Using the set of management objects, the application is installed according to the updated configuration, and executed.

### BACKGROUND

### 1. Field

The present invention relates to data processing in general, and to automated deployment of applications to application servers in particular.

### 2. Description of the Related Art

Application servers, such as IBM's WebSphere Application Server®, (WAS) support the deployment and management of Web applications ranging from simple Web sites to powerful e-business solutions. In the case of IBM's WebSphere Application Server®, the platform is a Java 2 Platform, Enterprise Edition (J2EE®) Web application server, similar to other application servers, such as BEA WebLogic® Server and Oracle Application Server.

### SUMMARY

According to one illustrative embodiment, a computer-implemented method deploys an updated configuration to a computer system. A number of processor units provides a set of management objects that enable commands and command parameters to configure an environment. Using the set of management objects, the set of processor units identifies a set of applications that are installed in a current configuration. The set of processor units executes a deployment script to automatically deploy the configuration. In executing the deployment script, for each application to be installed and using the set of management objects, the number of processor units determines if a version of the application is running. In response to determining that the version of the application is running, the number of processor units stops the application using the set of management objects, the version of the application. For each application to be installed, the number of processor units determines, using the set of management objects, if a version of the application is installed in the current configuration. In response to determining that the version of the application is installed, the number of processor units uninstalls, using the set of management objects, the version of the application. Using the set of management objects, the number of processor units installs the application according to the updated configuration. Using the set of management objects, the number of processor units executes the application.

According to other illustrative embodiments, a computer system and computer program product for executing a voice command are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a cloud computing environment in which illustrative embodiments may be implemented;

FIG. 4 is a diagram illustrating an example of abstraction layers of a cloud computing environment in accordance with an illustrative embodiment;

FIG. 5 is a diagram illustrating an example of a deployment management platform in accordance with an illustrative embodiment; and

FIG. 6 is a flowchart illustrating a process for automated deployment of an updated configuration in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

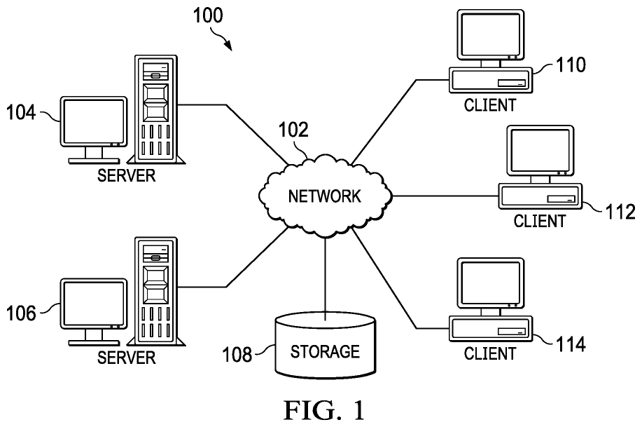

With reference now to the figures, and in particular, with reference to FIGS. 1-5, diagrams of data processing environments are provided in which illustrative embodiments may be implemented. It should be appreciated that FIGS. 1-5 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 may be, for example, a heterogeneous distributed computing environment such as a multi-cloud environment comprised of a plurality of clouds corresponding to different cloud providers and a plurality of edge devices.

Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent multiple computing nodes in one or more cloud environments. Alternatively, server 104 and server 106 may each represent a cluster of servers in one or more data centers.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Users, such as, for example, information technology operations administrators, multi-cloud infrastructure administrators, multi-cloud security analysts, and the like, corresponding to clients 110, 112, and 114 may utilize clients 110, 112, and 114 to access and utilize the multi-cloud asset error management services provided by server 104 and server 106.

Storage 108 is a network storage device capable of storing any type of data in a structured format or an unstructured format. In addition, storage 108 may represent a plurality of network storage devices. Further, storage 108 may store cloud identifiers, identifiers and network addresses for a plurality of servers, edge devices, and client devices. Furthermore, storage 108 may store other types of data, such as, for example, authentication or credential data that may include usernames, passwords, and the like associated with multi-cloud administrators and users.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

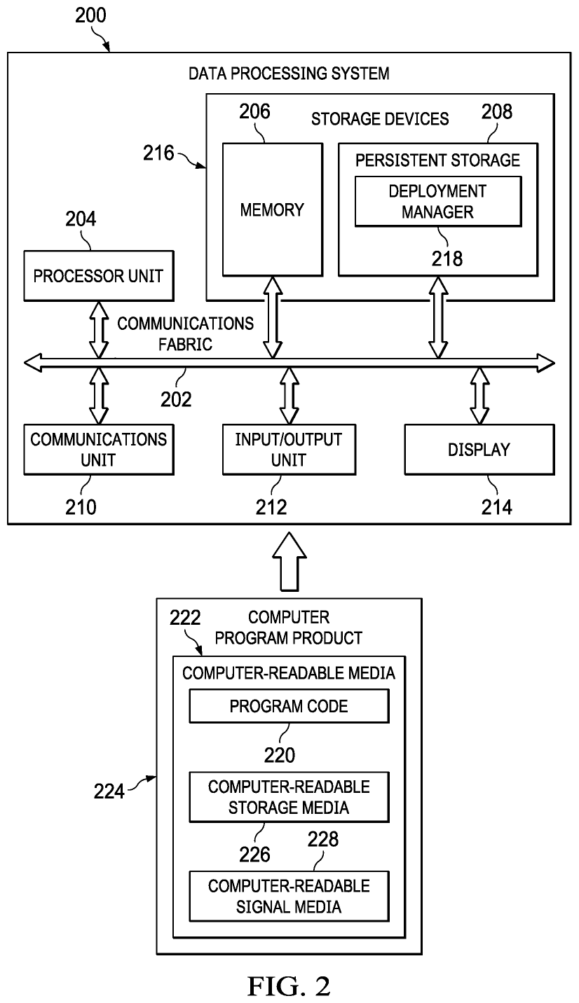

With reference now to FIG. 2, a diagram of a data processing system is depicted in accordance with an illustrative embodiment. Data processing system 200 is an example of a computer, such as server 104 in FIG. 1, in which computer-readable program code or instructions implementing the asset error management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

WAS provides the application logic enabling client components to interact with data resources and legacy applications. WAS also collaborates with the Web Server by exchanging client requests and application responses. An administrator can define multiple Application Servers where each would be running in its own Java Virtual Machine (JVM).

Within application servers such as WAS, the application server configuration provides information for starting and managing a server process to handle requests for enterprise applications and their components. WAS uses an administrative console to guide a user through deployment and system administration tasks. Actions taken by the user in the console modify a set of XML configuration files. Administrators can use the console to perform such tasks as adding, deleting, and stopping application servers, deploying new applications to a server, starting and stopping existing applications, and modifying certain configurations. In addition, administrators can use the console to manage variable, shared libraries, database connections, and other configurations that can span multiple application servers, configure product security, and collect data for performance and troubleshooting purposes.

Existing tools offer ways to administer and manage application server tasks without the need for the graphical user interface of the administrative console. Jython is an implementation of the high-level, dynamic, object-oriented language Python seamlessly integrated with the Java platform. Java Command Language (Jacl) is designed to be a universal scripting language for Java. Jython provides an interactive interpreter that can be used to interact with Java packages or with running Java applications. Java programmers can add the Jython libraries to their system to allow end users to write simple or complicated scripts that add functionality to the application. WAS contains a utility, wsadmin, that implements and extends the base Jython interpreter allowing an administrator to make additions, changes, or modifications to the server configuration.

In the on-demand service environment, many of the application server administration operations (making additions, changes or modifications to the server configuration) require manual, time-consuming steps. Moreover, operations require a dedicated administrator with a specific skill set to perform the tasks when that administrator's skills could be applied to additional responsibilities. For example, to execute a task such as “installing an application,” an administrator must be trained in the existing tool so that he or she understand the controls, becomes familiar with navigation and can follow a series of steps to achieve deploying an Enterprise Archive (EAR) file and start the application. Any small mistake in the detailed process (such as a missed check box or incorrect database version from the installation panel) can cause the installation to fail. In order to enable an application to connect to a database, the administrator would be required to launch the administrative console, login, click the security link in the navigation, and work with such properties as credentials, descriptions, variable entries pointing to the resource provider classes, resource links in the navigation, data sources, database names, connection pool information, and others.

In this example, persistent storage 208 stores deployment manager 218 for deploy prebuild configuration in a cloud environment using one or more deployment scripts 219. However, it should be noted that even though deployment manager 218 is illustrated as residing in persistent storage 208, in an alternative illustrative embodiment, deployment manager 218 may be a separate component of data processing system 200. For example, deployment manager 218 may be a hardware component coupled to communication fabric 202 or a combination of hardware and software components. In another alternative illustrative embodiment, a first set of components of deployment manager 218 may be located in data processing system 200 and a second set of components of deployment manager 218 may be located in a second data processing system, such as, for example, server 106 in FIG. 1.

Deployment manager 218 controls the process of automated deployment of an prebuild configuration in a cloud environment. The cloud environment may be, for example, network data processing system 100 in FIG. 1. Deployment manager 218 A provides a set of management objects that enable commands and command parameters to configure an environment. Using the set of management objects, deployment manager 218 identifies a set of applications that are installed in a current configuration. Deployment manager 218 executes deployment script 219 to automatically deploy the configuration. In executing the deployment script 219, for each application to be installed and using the set of management objects, Deployment manager 218 determines if a version of the application is running. In response to determining that the version of the application is running, Deployment manager 218 uses the set of management objects to stops the version of the application. For each application to be installed, Deployment manager 218 using the set of management objects to determine if a version of the application is installed in the current configuration. In response to determining that the version of the application is installed, Deployment manager 218 u uses the set of management objects to uninstall the version of the application. Deployment manager 218 uses the setup management objects to install the application according to the updated configuration. Deployment manager 218 uses the set of management objects to execute the application. As a result, data processing system 200 operates as a special purpose computer system in which Deployment manager 218 in data processing system 200 enables management of asset error remediation in a multi-cloud environment. In particular, Deployment manager 218 transforms data processing system 200 into a special purpose computer system as compared to currently available general computer systems that do not have Deployment manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 220 is located in a functional form on computer-readable media 222 that is selectively removable and may be loaded onto or transferred to data processing system 200 for running by processor unit 204. Program code 220 and computer-readable media 222 form computer program product 224. In one example, computer-readable media 222 may be computer-readable storage media 226 or computer-readable signal media 228.

In these illustrative examples, computer-readable storage media 226 is a physical or tangible storage device used to store program code 220 rather than a medium that propagates or transmits program code 220. Computer-readable storage media 226 may include, for example, an optical or magnetic disc that is inserted or placed into a drive or other device that is part of persistent storage 208 for transfer onto a storage device, such as a hard drive, that is part of persistent storage 208. Computer-readable storage media 226 also may take the form of a persistent storage, such as a hard drive, a thumb drive, or a flash memory that is connected to data processing system 200.

Alternatively, program code 220 may be transferred to data processing system 200 using computer-readable signal media 228. Computer-readable signal media 228 may be, for example, a propagated data signal containing program code 220. For example, computer-readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 222” can be singular or plural. For example, program code 220 can be located in computer-readable media 222 in the form of a single storage device or system. In another example, program code 220 can be located in computer-readable media 222 that is distributed in multiple data processing systems. In other words, some instructions in program code 220 can be located in one data processing system while other instructions in program code 220 can be located in one or more other data processing systems. For example, a portion of program code 220 can be located in computer-readable media 222 in a server computer while another portion of program code 220 can be located in computer-readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

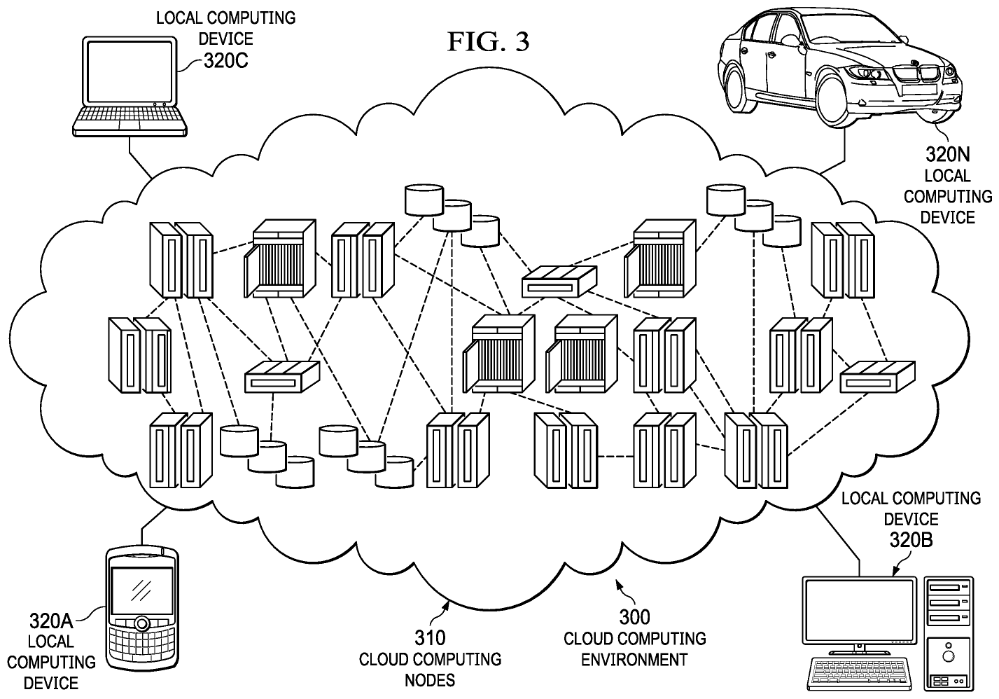

With reference now to FIG. 3, a diagram illustrating a cloud computing environment is depicted in which illustrative embodiments may be implemented. In this illustrative example, cloud computing environment 300 includes a set of one or more cloud computing nodes 310 with which local computing devices used by cloud consumers, such as, for example, personal digital assistant or smart phone 320A, desktop computer 320B, laptop computer 320C, and/or automobile computer system 320N, may communicate.

Cloud computing nodes 310 may communicate with one another and may be grouped physically or virtually into one or more networks, such as private, community, public, or hybrid clouds as described hereinabove, or a combination thereof. This allows cloud computing environment 300 to offer infrastructure, platforms, and/or software as services for which a cloud consumer does not need to maintain resources on a local computing device, such as local computing devices 320A-320N. It is understood that the types of local computing devices 320A-320N are intended to be illustrative only and that cloud computing nodes 310 and cloud computing environment 300 can communicate with any type of computerized device over any type of network and/or network addressable connection using a web browser, for example.

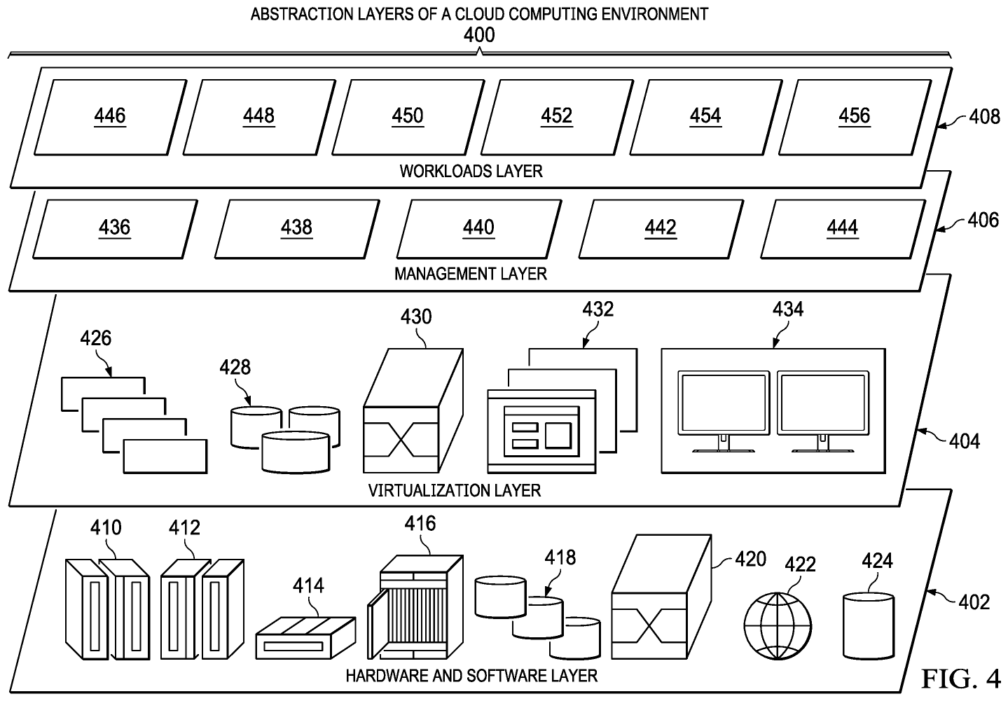

With reference now to FIG. 4, a diagram illustrating abstraction model layers is depicted in accordance with an illustrative embodiment. The set of functional abstraction layers shown in this illustrative example may be provided by a cloud computing environment, such as cloud computing environment 300 in FIG. 3. It should be understood in advance that the components, layers, and functions shown in FIG. 4 are intended to be illustrative only and embodiments of the invention are not limited thereto. As depicted, the following layers and corresponding functions are provided.

Abstraction layers of a cloud computing environment 400 include hardware and software layer 402, virtualization layer 404, management layer 406, and workloads layer 408. Hardware and software layer 402 includes the hardware and software components of the cloud computing environment. The hardware components may include, for example, mainframes 410, RISC (Reduced Instruction Set Computer) architecture-based servers 412, servers 414, blade servers 416, storage devices 418, and networks and networking components 420. In some illustrative embodiments, software components may include, for example, network application server software 422 and database software 424.

Virtualization layer 404 provides an abstraction layer from which the following examples of virtual entities may be provided: virtual servers 426; virtual storage 428; virtual networks 430, including virtual private networks; virtual applications and operating systems 432; and virtual clients 434.

In one example, management layer 406 may provide the functions described below. Resource provisioning 436 provides dynamic procurement of computing resources and other resources, which are utilized to perform tasks within the cloud computing environment. Metering and pricing 438 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 440 provides access to the cloud computing environment for consumers and system administrators. Service level management 442 provides cloud computing resource allocation and management such that required service levels are met. Service level agreement (SLA) planning and fulfillment 444 provides pre-arrangement for, and procurement of, cloud computing resources for which a future requirement is anticipated in accordance with an SLA.

Workloads layer 408 provides examples of functionality for which the cloud computing environment may be utilized. Example workloads and functions, which may be provided by workload layer 408, may include mapping and navigation 446, software development and lifecycle management 448, virtual classroom education delivery 450, data analytics processing 452, transaction processing 454, and mobile desktop 456.

In one illustrative example, planning and fulfillment 444 may require the deployment of numerous software modules with different configurations and dependencies to create the computing environment. This environment creation process involves stopping running modules, uninstalling those modules, and removing the associated archive file from the console. Updated modules are then installed and restarted. cloud computing resource are then made available after restarting the server.

A fresh environment creation often requires the prebuild deployment of 40 to 50 separate software modules, together with all of their configurations and dependencies. Environment creation via manual deployment of the modules, as well as dependencies, can often exceed 10 hours of labor by an information technology specialist, depending on the network speeds.

Thus, the illustrative embodiments provide a computer implemented method, apparatus, system, and computer program products for automated deployment of an updated configuration to a computer system. A number of processor units provides a set of management objects that enable commands and command parameters to configure an environment. Using the set of management objects, the set of processor units identifies a set of applications that are installed in a current configuration. The set of processor units executes a deployment script to automatically deploy the configuration. In executing the deployment script, for each application to be installed and using the set of management objects, the number of processor units determines if a version of the application is running. In response to determining that the version of the application is running, the number of processor units stops the application using the set of management objects, the version of the application. For each application to be installed, the number of processor units determines, using the set of management objects, if a version of the application is installed in the current configuration. In response to determining that the version of the application is installed, the number of processor units uninstalls, using the set of management objects, the version of the application. Using the set of management objects, the number of processor units installs the application according to the updated configuration.

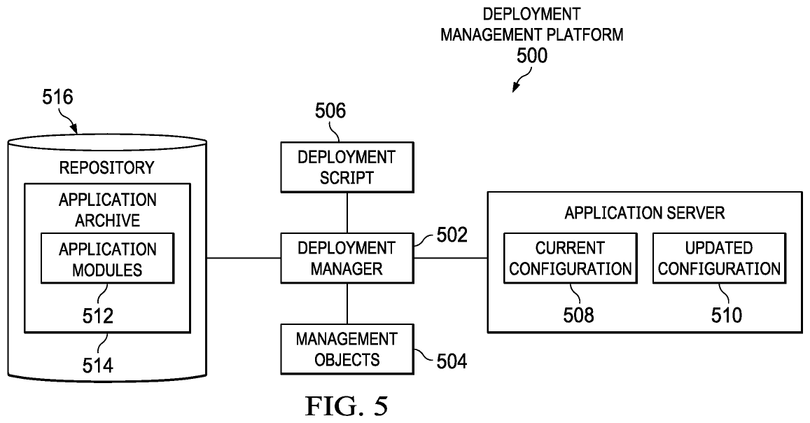

Referring now to FIG. 5, a deployment management platform is shown according to an illustrative embodiment. Deployment management platform 500 is a software application, executing within a management layer of a cloud computing environment, such as management layer 406 of FIG. 4.

Deployment manager 502 is installation management tool that runs product installations, updates, and uninstallations with integrated prerequisite and interdependency checking. Deployment manager 502 provides a scripting interface used to implement an architecture for incorporating scripting into Java applications and applets. The architecture works as an interface between Java applications and scripting languages. Using this framework, Deployment manager 502 can make various Java objects available through language-specific interfaces to scripts.

Management objects 504 enable commands and command parameters to configure a computing environment. In this illustrative example, deployment manager 502 provides management objects 504 that enable server configuration and management capabilities, including:

AdminControl: The AdminControl object is used for operational control. It communicates with managed objects that represent live objects running an application server process. It includes commands to query existing running objects and their attributes and to invoke operations on the objects. In addition to the operational commands, the AdminControl object supports commands to query information about the connected server, to trace clients, to reconnect to a server, and to start and stop a server.

AdminConfig—The AdminConfig object is used to manage the configuration information that is stored in the repository. This object communicates with the Application Server configuration service component to make configuration inquiries and changes. The AdminConfig object can query existing configuration objects, create configuration objects, modify existing objects, and remove configuration objects.

AdminApp—The AdminApp object can update application metadata, map virtual hosts to web modules, and map servers to modules for applications already installed. However, changes to an application, such as specifying a library for the application to use or setting session management configuration properties, are performed using the AdminConfig object.

AdminTask—The AdminTask object is used to access a set of task-oriented administrative commands that provide an alternative way to access the configuration commands and the running object management commands. The administrative commands run simple and complex commands that are discovered dynamically when the scripting client is started.

Deployment manager 502 executes deployment script 506, directing management objects 504 identify a set of applications that are installed in a current configuration 508, and to automatically deploy the updated configuration 510. One or more application modules 512 for the updated configuration 510 can be contained in application archive 514 located in repository 516.

Application archive 514 is a file that is composed of one or more files along with metadata that can include source volume and medium information, file directory structure, error detection and recovery information, file comments, and usually employs some form of lossless compression. Application archive 514 files may be encrypted in part or as a whole. Application archive 514 is used to collect multiple data files together into a single file for easier portability and storage, or simply to compress files to use less storage space.

In one illustrative embodiment, application archive 514 is an enterprise archive repository (EAR). Enterprise archive repository is a file format used by object-oriented programming (“OOP”) methodologies, such as Java 2 Platform Enterprise Edition, for packaging one or more modules into a single archive so that the deployment of the various modules onto an application server happens simultaneously and coherently. Enterprise archive repository contains extensible markup language metadata files, sometimes called deployment descriptors, which provide details on how to deploy the application components contained within the enterprise archive repository.

Application archive 514 includes metadata markups that define the various application components for the associated application. Application archive 514 allows the various application components to be contained within a single file.

In one illustrative example, deployment manager 502 identifies one or more application modules 512 within application archive 514 of the updated configuration 510. Deployment manager 502 generates a list of the application modules 512 contained within application archive 514.

Application modules 512 include one or more separately installable products which together comprise an application. Application modules 512 can operate independently or can be dependent on other application modules 512. Application modules 512 can be, for example but not limited to, web applications, enterprise java beans, web services uniform resource identifiers (URI), web components, message queues, batch processes and data sources. Web applications and web components may deliver, for example but not limited to, HTML, java scripts, and servlets. Enterprise java beans may, for example but not limited to, connect the application to a particular database. Batch process may, for example but not limited to, be long running tasks that may not have any interaction with a user.

Application modules 512 are stored in repository 516. Repository 516, also sometimes called an archive repository, or EAR repository, is the storage location of Application modules 512. Repository 516 can include metadata and product binary files.

For each application to be installed, deployment manager 502 stops any version of the application that is running, according to deployment script 506. deployment manager 502 uninstalls any version of the application that is installed as part of the current configuration. Deployment manager 502 installs and executes the application, according to the updated configuration as identified from deployment script 506.

In one illustrative example, application archive 514 includes metadata markups that define the various application components for the associated application. Application archive 514 allows the various application components to be contained within a single file. deployment manager 502 automatically identifies dependencies of the application according to the updated configuration. the dependencies can be identified within an enterprise archive file of the updated configuration.

In one illustrative example, deployment manager 502 automatically installs the dependencies according to the enterprise archive file. During deployment, deployment manager 502 follows instructions in the enterprise archive file to resolve external dependencies, specify security settings, assign transaction attributes, move the application components to the server, and generate any requisite classes and interfaces. For example, deployment manager 502 may identify a deployment ordering sequence among the application and the dependencies, as defined in the enterprise archive file. deployment manager 502 then installs the application and the dependencies according to the deployment ordering sequence

In these illustrative examples,the set of management objects enables deployment of the updated configuration to the computer system without user log in to an administrative console. Automated deployment according to the deployment script enables unilaterally provisioning computing capabilities in a cloud environment according to the updated configuration.

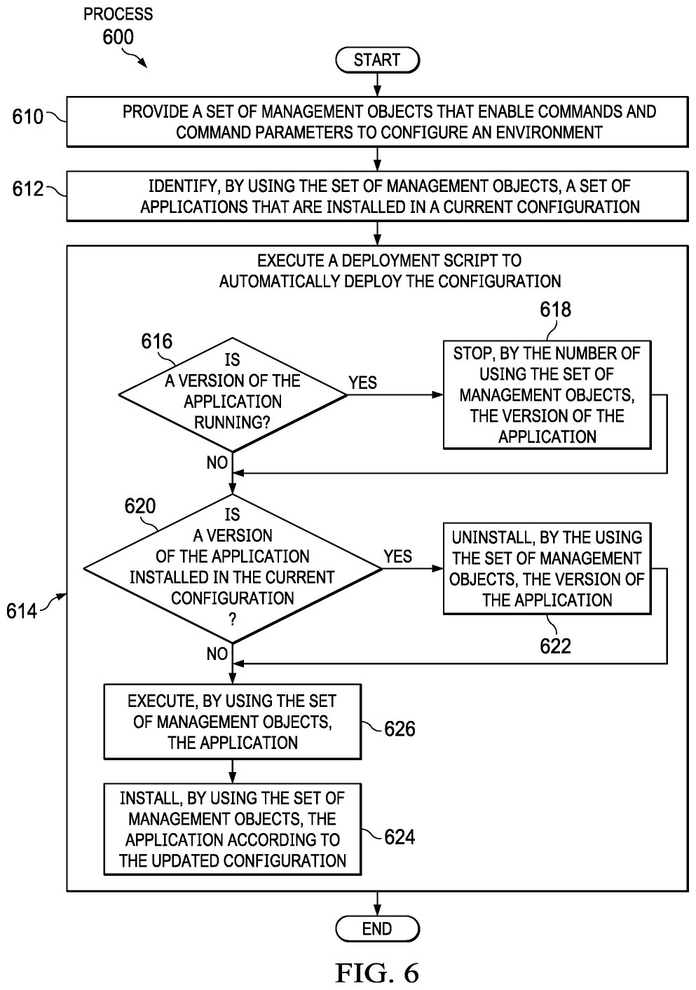

With reference now to FIG. 6, a diagram illustrating an example of a process for automated deployment of an updated configuration is depicted in accordance with an illustrative embodiment. Process 600 may be implemented in a multi-cloud asset error manager, such as, for example, deployment manager 502 in FIG. 5.

The process begins by providing a set of management objects that enable commands and command parameters to configure an environment. (step 610). Using a set of management objects, the process identifies a set of applications that are installed in a current configuration (step 612). The process executes a deployment script to automatically deploy an updated configuration (step 614). In one illustrative example, the process may optionally include identifying one or more application modules within an enterprise archive file of the updated configuration and generating a list of the application modules contained within the enterprise archive file.

For each application to be installed, the process uses the set of management objects to determine if a version of the application is running (step 616). In response to determining that the version of the application is running (“yes” at step 616), the process uses the set of management objects to stop the version of the application (step 618);

For each application to be installed, the process uses the set of management objects to determine if a version of the application is installed in the current configuration (step 620). In response to determining that the version of the application is installed (“yes” at step 620), the process uses the set of management objects to uninstall the version of the application (step 622).

The process uses the set of management objects to install the application according to the updated configuration (step 624). In one illustrative example, installing the application according to the updated configuration may further include using the set of management objects to automatically identify dependencies of the application according to the current configuration. The dependencies can be identified with an enterprise archive file of the updated configuration, which can include a deployment ordering sequence among the application and the dependencies defined in the enterprise archive file. Using the set of management objects, the application and the dependencies can be installed according to the deployment ordering sequence.

The process uses the set of management objects to execute the application (step 626). The process terminates thereafter.

Thus, the illustrative embodiments provide a computer implemented method, apparatus, system, and computer program products for automated deployment of an updated configuration to a computer system. A number of processor units provides a set of management objects that enable commands and command parameters to configure an environment. Using the set of management objects, the set of processor units identifies a set of applications that are installed in a current configuration. The set of processor units executes a deployment script to automatically deploy the configuration. In executing the deployment script, for each application to be installed and using the set of management objects, the number of processor units determines if a version of the application is running. In response to determining that the version of the application is running, the number of processor units stops the application using the set of management objects, the version of the application. For each application to be installed, the number of processor units determines, using the set of management objects, if a version of the application is installed in the current configuration. In response to determining that the version of the application is installed, the number of processor units uninstalls, using the set of management objects, the version of the application. Using the set of management objects, the number of processor units installs the application according to the updated configuration.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for automated deployment of an updated configuration, the method comprising:
providing, by a number of processor units, a set of management objects that enable commands and command parameters to configure an environment; and
identifying, by the number of processor units using the set of management objects, a set of applications that are installed in a current configuration;
executing, by the number of processor units, a deployment script to automatically deploy the configuration, wherein executing the deployment script comprises:
for each application to be installed, determining, by the number of processor units using the set of management objects, if a version of the application is running;
in response to determining that the version of the application is running, stopping, by the number of processor units using the set of management objects, the version of the application;
for each application to be installed, determining, by the number of processor units using the set of management objects, if the version of the application is installed in the current configuration;
in response to determining that the version of the application is installed, uninstalling, by the number of processor units using the set of management objects, the version of the application;
installing, by the number of processor units using the set of management objects, the application according to the updated configuration; and
executing, by the number of processor units using the set of management objects, the application.

2. The computer-implemented method of claim 1, further comprising:
identifying, by the number of processor units, one or more application modules within an enterprise archive file of the updated configuration; and
generating, by the number of processor units, a list of the application modules contained within the enterprise archive file.

3. The computer-implemented method of claim 1, wherein installing the application according to the updated configuration further comprises:
automatically identifying, by the number of processor units using the set of management objects, dependencies of the application according to the current configuration; and
automatically installing, by the number of processor units using the set of management objects, the dependencies.

4. The computer-implemented method of claim 3, wherein automatically identifying the dependencies further comprises:
identifying, by the number of processor units using the set of management objects, the dependencies within an enterprise archive file of the updated configuration;
and automatically installing, by the number of processor units using the set of management objects, the dependencies according to the enterprise archive file.

5. The computer-implemented method of claim 4, wherein automatically installing the dependencies according to the enterprise archive file further comprises:
identifying, by the number of processor units using the set of management objects, a deployment ordering sequence among the application and the dependencies defined in the enterprise archive file; and
installing, by the number of processor units using the set of management objects, the application and the dependencies according to the deployment ordering sequence.

6. The computer-implemented method of claim 1, wherein the set of management objects enables deployment of the updated configuration to a computer system without user log in to an administrative console.

7. The computer-implemented method of claim 1, wherein automated deployment according to the deployment script enables unilaterally provisioning computing capabilities in a cloud environment according to the updated configuration.

8. A computer system comprising:
a number of processor units, wherein the number of processor units executes instructions:
to provide a set of management objects that enable commands and command parameters to configure an environment; and
to identify a set of applications that are installed in a current configuration;
to execute a deployment script to automatically deploy the configuration, the deployment script including instructions:
for each application to be installed, to determine, using the set of management objects, if a version of the application is running;
in response to determining that the version of the application is running, to stop, using the set of management objects, the version of the application;
for each application to be installed, to determine, using the set of management objects, if a version of the application is installed in the current configuration;
in response to determining that the version of the application is installed, to uninstall, using the set of management objects, the version of the application;
to install, using the set of management objects, the application according to the updated configuration; and
to execute, using the set of management objects, the application.

9. The computer system of claim 8, wherein the number of processor units further executes the instructions:
to identify one or more application modules within an enterprise archive file of the updated configuration; and
to generate a list of the application modules contained within the enterprise archive file.

10. The computer system of claim 8, wherein in installing the application according to the updated configuration, the number of processor units further executes the instructions:
to automatically identify, using the set of management objects, dependencies of the application according to the current configuration; and
to automatically install, using the set of management objects, the dependencies.

11. The computer system of claim 10, wherein in automatically identifying the dependencies, the number of processor units further executes the instructions:
to identify, using the set of management objects, the dependencies within an enterprise archive file of the updated configuration; and
to automatically install, using the set of management objects, the dependencies according to the enterprise archive file.

12. The computer system of claim 11, wherein in automatically installing the dependencies according to the enterprise archive file, the number of processor units further executes the instructions:
to identify, using the set of management objects, a deployment ordering sequence among the application and the dependencies defined in the enterprise archive file; and
to install, using the set of management objects, the application and the dependencies according to the deployment ordering sequence.

13. The computer system of claim 8, wherein the set of management objects enables deployment of the updated configuration to the computer system without user log in to an administrative console.

14. The computer system of claim 8, wherein automated deployment according to the deployment script enables unilaterally provisioning computing capabilities in a cloud environment according to the updated configuration.

15. A computer program product for automated deployment of an updated configuration, the computer program product comprising a computer readable storage medium having program instructions embodied therewith, the program instructions executable by a computer system to cause the computer system to perform a method of:
providing, by a number of processor units, a set of management objects that enable commands and command parameters to configure an environment; and
identifying, by the number of processor units using the set of management objects, a set of applications that are installed in a current configuration;
executing, by the number of processor units, a deployment script to automatically deploy the configuration, wherein executing the deployment script comprises:
for each application to be installed, determining, by the number of processor units using the set of management objects, if a version of the application is running;
in response to determining that the version of the application is running, stopping, by the number of processor units using the set of management objects, the version of the application;
for each application to be installed, determining, by the number of processor units using the set of management objects, if a version of the application is installed in the current configuration;
in response to determining that the version of the application is installed, uninstalling, by the number of processor units using the set of management objects, the version of the application;
installing, by the number of processor units using the set of management objects, the application according to the updated configuration; and
executing, by the number of processor units using the set of management objects, the application.

16. The computer program product of claim 15, further comprising:
identifying, by the number of processor units, one or more application modules within an enterprise archive file of the updated configuration; and
generating, by the number of processor units, a list of the application modules contained within the enterprise archive file.

17. The computer program product of claim 15, wherein installing the application according to the updated configuration further comprises:
automatically identifying, by the number of processor units using the set of management objects, dependencies of the application according to the current configuration; and
automatically installing, by the number of processor units using the set of management objects, the dependencies.

18. The computer program product of claim 17, wherein automatically identifying the dependencies further comprises:
identifying, by the number of processor units using the set of management objects, the dependencies within an enterprise archive file of the updated configuration; and
automatically installing, by the number of processor units using the set of management objects, the dependencies according to the enterprise archive file.

19. The computer program product of claim 18, wherein automatically installing the dependencies according to the enterprise archive file further comprises:
identifying, by the number of processor units using the set of management objects, a deployment ordering sequence among the application and the dependencies defined in the enterprise archive file; and
installing, by the number of processor units using the set of management objects, the application and the dependencies according to the deployment ordering sequence.

20. The computer program product of claim 15, wherein the set of management objects enables deployment of the updated configuration to the computer system without user log in to an administrative console; and.
wherein automated deployment according to the deployment script enables unilaterally provisioning computing capabilities in a cloud environment according to the updated configuration.
